(19) United States
(12) Patent Application Publication
(10) Pub. No.: US 2024/0238137 A1
(43) Pub. Date: Jul. 18, 2024

(54) WHEELCHAIR CUSTOMIZATION SYSTEM, METHODS AND COMPONENTS

(71) Applicant: ROVE CONCEPTS PTY LTD, OAKLEIGH, VICTORIA (AU)

(72) Inventor: RYAN KENDALL TILLEY, OAKLEIGH, VICTORIA (AU)

(21) Appl. No.: 18/562,017

(22) PCT Filed: May 13, 2022
(86) PCT No.: PCT/AU2022/050460

§ 371 Date: Nov. 17, 2023

(30) Foreign Application Priority Data
May 18, 2021 (AU) 2021901478

(51) Int. Cl. A61G 5/10; B60B 35/00

(52) U.S. Cl. CPC A61G 5/10; B60B 35/005; B60B 2200/22; B60B 2900/113; B60B 2900/351; B60B 2900/521

(57) ABSTRACT

A system for person mobility devices such as wheelchairs. The system includes a personal mobility apparatus having a wheel support portion, and an axle engaging portion that is attachable to and detachable from the wheel support portion. The wheel support portion may be a body portion or a frame portion of the personal mobility apparatus that is formed separately to the wheel support portion. The wheel support portion may be shaped so as to fit a complementary shape of the axle engaging portion. The system allows for customization of a mobility apparatus for a particular application or user by adjusting the position or orientation of the wheel axles.

### FIELD OF THE INVENTION

The present invention relates generally to the field of person mobility devices such as wheelchairs. In particular, but not exclusively, the invention relates to a system allowing for a user to customize their wheelchair with regard to wheel axle position and geometry.

### BACKGROUND TO THE INVENTION

Wheelchair design and technology is advancing at a greater rate than ever before, with new lightweight materials and improved designs providing greater choice for users. Long gone are the days when a wheelchair user was provided with a “standard” wheelchair, and was forced to essentially make the best of it.

With the greater amount of choice comes a higher degree of specialisation in wheelchair design. In that regard, it has become clear that a single wheelchair design is not necessarily optimal for all intended uses. Indeed, some designs may only be useful for a narrow set of applications. For example, a wheelchair having broader tyres for traversing over soft terrain is not ideal for everyday use on pavements given the limited maneuverability and increased drag caused by broad tyres. The prior art provides a solution in the form of replaceable wheels, and also broadening devices which attach to the tyres. However, that solution raises a new problem in that many wheelchairs cannot accommodate alternative wheels or tyre attachment devices.

In some circumstances, a wheelchair which is suitable for a user at one point in time may become less suitable at a later time. A user's physical condition may deteriorate or improve over time such that adjustments to a wheelchair need be made, or the wheelchair replaced. Alternatively, a user's body may change physically such as when a child grows into an adolescent, weight is gained or lost, or a limb is amputated. In such circumstances, it may be necessary to modify or replace the wheelchair, both of which can be expensive.

It is an aspect of the present invention to provide an improvement to prior art wheelchairs and wheelchair components so as to facilitate customization required to suit a user, or for a particular application. It is a further aspect of the present invention to provide a useful alternative to prior art wheelchairs and wheelchair components.

The discussion of documents, acts, materials, devices, articles and the like is included in this specification solely for the purpose of providing a context for the present invention. It is not suggested or represented that any or all of these matters formed part of the prior art base or were common general knowledge in the field relevant to the present invention as it existed before the priority date of each claim of this application.

### SUMMARY OF THE INVENTION

In a first aspect, but not necessarily the broadest aspect, the present invention provides a system comprising: a personal mobility apparatus comprising a wheel support portion, and an axle engaging portion that is attachable to the wheel support portion.

In one embodiment of the first aspect, the axle engaging portion is detachable from the wheel support portion

In one embodiment of the first aspect, the wheel support portion is a body portion or a frame portion of the personal mobility apparatus.

In one embodiment of the first aspect, the axle engaging portion is formed separately to the wheel support portion.

In one embodiment of the first aspect, the wheel support portion is shaped so as to fit a complementary shape of the axle engaging portion.

In one embodiment of the first aspect, the complementary shape of the wheel support portion is (i) a cavity formed in the wheel support portion or (ii) a protuberance extending from the wheel support portion.

In one embodiment of the first aspect, the cavity or the protuberance is generally wedge-shaped in cross-section.

In one embodiment of the first aspect, the system comprises reversible fixing means or a reversible fixing sub-system configured to reversibly fix the axle engaging portion to the wheel support portion.

In one embodiment of the first aspect, the reversible fixing means or the reversible fixing sub-system comprises any one or more of a fastener, a fastener hole formed in the wheel support portion and/or the axle engaging portion, a fastener receiving portion formed in the wheel support portion and/or the axle engaging portion, a clip, a band, or a clamp.

In one embodiment of the first aspect, the wheel support portion and/or the axle engaging portion is/are configured such that the axle engaging portion is attachable in a single orientation to the wheel support portion.

In one embodiment of the first aspect, the axle engaging portion is formed as a solid body.

In one embodiment of the first aspect, the axle engaging portion is formed from a metal.

In one embodiment of the first aspect, the metal is a lightweight metal, including aluminium, an aluminium alloy, titanium, a titanium alloy, a magnesium, a magnesium alloy, beryllium, or a beryllium alloy.

In one embodiment of the first aspect, the axle engaging portion is configured to reversibly engage a wheel axle intended for engagement.

In one embodiment of the first aspect, the reversible engagement is reliant on a structure of a wheel axle intended for engagement.

In one embodiment of the first aspect, the axle engaging portion comprises a passage configured to receive a wheel axle intended for engagement.

In one embodiment of the first aspect, the axle engaging portion comprises an extension portion configured to extend generally laterally outwardly from the personal mobility apparatus.

In one embodiment of the first aspect, the passage is formed at least in part in the extension portion.

In one embodiment of the first aspect, the axle engaging portion is configured to engage a wheel axle at (i) a predetermined position relative to a point of the personal mobility apparatus, or relative to the ground and/or (ii) at an angle relative to the ground.

In one embodiment of the first aspect, the axle engaging portion is configured to engage a wheel axle such that a wheel rotating on the wheel axle is disposed laterally outwardly so as to accommodate a wheel having a tyre width greater than about 35 mm. 40 mm. 45 mm. 50 mm, 55 mm, 60 mm, 65 mm, 70 mm, 75 mm, 80 mm, 85 mm, 90 mm, 95 mm, or 100 mm.

In one embodiment of the first aspect, the axle engaging portion is configured to engage a wheel axle in a more forward position or a more rearward position or a more upward position or a more downward position compared to a previous position or a standard position.

In one embodiment of the first aspect, the axle engaging portion is configured to engage a wheel axle to provide a camber angle of about 0 degrees, or greater than about 1 degrees, 2 degrees, 3 degrees, 4 degrees or 5 degrees.

In one embodiment of the first aspect, the system comprises a wheel axle configured to be engageable by the axle engaging portion.

In one embodiment of the first aspect, the system comprises a plurality of axle engaging portions, each member of the plurality being differentially configured such that when attached to a frame member of a personal mobility apparatus, each member of the plurality positions and/or angles the axle differently.

In one embodiment of the first aspect, the system comprises instructions in the form of a computer readable electronic file, printed material, an audio recording, or a video recording containing text or images or sound instructing the attachment of an axle engaging portion of the system with a wheel support portion of the system.

In one embodiment of the first aspect, the personal mobility apparatus is a wheelchair.

In a second aspect, the present invention provides a personal mobility apparatus comprising a wheel support portion configured to attach to an axle engaging portion that is attachable to the wheel support portion.

In one embodiment of the second aspect, the axle engaging portion is detachable form the wheel support portion.

In one embodiment of the second aspect, the wheel support portion is a body portion or a frame portion of the personal mobility apparatus.

In one embodiment of the second aspect, the axle engaging portion is formed separately to the wheel support portion.

In one embodiment of the second aspect, the wheel support portion is shaped so as to fit a complementary shape of the axle engaging portion.

In one embodiment of the second aspect, wherein the complementary shape of the wheel support portion is (i) a cavity formed in the wheel support portion or (ii) a protuberance extending from the wheel support portion.

In one embodiment of the second aspect, the cavity or the protuberance is generally wedge-shaped in cross-section.

In one embodiment of the second aspect, the personal mobility apparatus comprises reversible fixing means or a reversible fixing system configured to reversibly fix the axle engaging portion to the wheel support portion.

In one embodiment of the second aspect, the reversible fixing means or the reversible fixing system comprises any one or more of a fastener, a fastener hole formed in the wheel support portion, a fastener receiving portion formed in the wheel support portion, a clip, a band, or a clamp.

In one embodiment of the second aspect, the wheel support portion is configured such that the axle engaging portion is attachable in a single orientation to the wheel support portion.

In one embodiment of the second aspect, the personal mobility apparatus is a wheelchair.

In a third aspect, the present invention provides an axle engaging portion that is attachable to the wheel support portion of a personal mobility apparatus comprising a wheel support portion.

In one embodiment of the third aspect, the axle engaging portion is detachable from the wheel support portion.

In one embodiment of the third aspect, the axle engaging portion is formed separately to the wheel support portion.

In one embodiment of the third aspect, the wheel support portion is shaped so as to fit a complementary shape of the axle engaging portion.

In one embodiment of the third aspect, the axle engaging portion comprises reversible fixing means or a reversible fixing system configured to reversibly fix the axle engaging portion to the wheel support portion.

In one embodiment of the third aspect, the reversible fixing means or the reversible fixing system comprises any one or more of a fastener, a fastener hole formed in the wheel support portion and/or the axle engaging portion, a fastener receiving portion formed in the wheel support portion and/or the axle engaging portion, a clip, a band, or a clamp.

In one embodiment of the third aspect, the axle engaging portion is configured so as to be attachable in a single orientation to the wheel support portion.

In one embodiment of the third aspect, the axle engaging portion is formed as a solid body.

In one embodiment of the third aspect, the axle engaging portion is formed from a metal.

In one embodiment of the third aspect, the metal is a lightweight metal, including aluminium, an aluminium alloy, titanium, a titanium alloy, a magnesium, a magnesium alloy, beryllium, or a beryllium alloy.

In one embodiment of the third aspect, the axle engaging portion is configured to reversibly engage a wheel axle intended for engagement.

In one embodiment of the third aspect, the reversible engagement is reliant on a structure of a wheel axle intended for engagement.

In one embodiment of the third aspect, the axle engaging portion comprises a passage configured to receive a wheel axle intended for engagement.

In one embodiment of the third aspect, the axle engaging portion comprises an extension portion configured to extend generally laterally outwardly from the personal mobility apparatus.

In one embodiment of the third aspect, the passage is formed at least in part in the extension portion.

In one embodiment of the third aspect, the axle engaging portion is configured to engage a wheel axle at (i) a predetermined position relative to a point of the personal mobility apparatus, or relative to the ground and/or (ii) at an angle relative to the ground.

In one embodiment of the third aspect, the axle engaging portion is configured to engage a wheel axle such that a wheel rotating on the wheel axle is disposed laterally outwardly so as to accommodate a wheel having a tyre width greater than about 35 mm. 40 mm. 45 mm. 50 mm, 55 mm, 60 mm, 65 mm, 70 mm, 75 mm, 80 mm, 85 mm, 90 mm, 95 mm, or 100 mm.

In one embodiment of the third aspect, the axle engaging portion is configured to engage a wheel axle in a more forward position or a more rearward position or a more upward position or a more downward position compared to a previous position or a standard position.

In one embodiment of the third aspect, the axle engaging portion is configured to engage a wheel axle to provide a camber angle of about 0 degrees, or greater than about 1 degrees, 2 degrees, 3 degrees, 4 degrees or 5 degrees.

In one embodiment of the third aspect, the axle engaging portion comprises a wheel axle configured to be engageable by the axle engaging portion.

In one embodiment of the third aspect, the personal mobility apparatus is a wheelchair.

In a fourth aspect, the present invention provides a plurality of axle engaging portions, each member of the plurality being any embodiment of the third aspect, each member of the plurality being differentially configured such that when attached to a frame member of a personal mobility apparatus, each member positions and/or angles the axle differently.

In a fifth aspect, the present invention provides a method of customizing a personal mobility device comprising the step of attaching an axle engaging portion of any embodiment of the third aspect to the wheel support portion of a personal mobility apparatus of any embodiment of the second aspect.

In one embodiment of the fifth aspect, the method comprises the step of detaching the axle engaging portion from the wheel support portion.

In one embodiment of the fifth aspect, the method comprises the step of selecting an axle engaging portion according to a need or preference of an intended user of the personal mobility device, or an intended application of the personal mobility device.

In one embodiment of the fifth aspect, the axle engaging portion is selected from the plurality of axle engaging portions of any embodiment of the fourth aspect.

In a sixth aspect, the present invention provides a personal mobility apparatus produced the method of any embodiment of the fifth aspect.

In a seventh aspect, the present invention provides a personal mobility apparatus of any embodiment of the second aspect having attached thereto an axle engaging portion of any embodiment of the third aspect.

### BRIEF DESCRIPTION OF THE FIGURES

FIG. 1 illustrates in perspective view a preferred socket of the present invention, forming part of the frame of a wheelchair.

FIG. 2A illustrates in front perspective view, the socket drawn in FIG. 1 with a preferred axle engaging portion of the present invention. Threaded fasteners are ready to engage the axle engaging portion. The arrow indicates the direction of movement of the axle engaging portion into the socket as occurs during installation.

FIG. 2B is a rear perspective view of the arrangement drawn in FIG. 2A.

FIG. 3A illustrates in front perspective view the socket and axle engaging portion of FIG. 1 having been attached together and secured with threaded fasteners.

FIG. 3B is a rear perspective view of the arrangement drawn in FIG. 3A.

FIG. 4A is a cross-sectional plan view of the arrangement drawn in FIG. 3A.

FIG. 4B is a cross-sectional lateral view of the arrangement drawn in FIG. 3A.

FIG. 5A is an exploded view of the arrangement shown in FIG. 4A.

FIG. 5B is an exploded view of the arrangement shown in FIG. 4B.

FIG. 6 illustrates a series of axle engaging portions useful for setting a wheel axle position relatively forward or relatively rearward to the wheelchair. The left-hand series of drawings are in front view, and the right-hand in plan view.

FIG. 7 illustrates in front perspective view alternative axle engaging portions useful for laterally offsetting a wheel axle relatively close or relatively distant to the wheelchair.

FIG. 8 illustrates alternative axle engaging portions useful for setting the camber angle of wheelchair wheels to a relatively small angle or a relatively large angle. From top downwards, the respective views are lateral, lateral cross-sectional, front perspective, front, rear perspective, and rear.

Unless otherwise indicated herein, features of the drawings labelled with the same numeral are taken to be the same features, or at least functionally similar features, when used across different drawings.

The drawings are not prepared to any particular scale or dimension and are not presented as being a completely accurate presentation of the various embodiments.

### DETAILED DESCRIPTION OF THE INVENTION AND PREFERRED EMBODIMENTS THEREOF

After considering this description it will be apparent to one skilled in the art how the invention is implemented in various alternative embodiments and alternative applications. However, although various embodiments of the present invention will be described herein, it is understood that these embodiments are presented by way of example only, and not limitation. As such, this description of various alternative embodiments should not be construed to limit the scope or breadth of the present invention. Furthermore, statements of advantages or other aspects apply to specific exemplary embodiments, and not necessarily to all embodiments, or indeed any embodiment covered by the claims.

Throughout the description and the claims of this specification the word “comprise” and variations of the word, such as “comprising” and “comprises” is not intended to exclude other additives, components, integers or steps.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may.

As used herein, positional terms such as “lateral”, “across”, “above”, “below”, “higher”, “lower”, “upward”, “downward”, “plan view” and the like are to be considered with reference to a wheelchair as used in a normal upright position so as to allow a seated user to roll across a generally horizontal surface.

When an item is referred to as “configured” in a certain manner, the configuration may be by way of any one or more of: shape, dimension, orientation, material(s) of fabrication, flexibility, elasticity, deformability, resilience, durability, inflexibility, movability, lack of movability, and control of movability.

The present invention is predicated at least in part on the inventor's discovery that in many instances a wheelchair can be customized for a particular application or user by adjusting the position or orientation of the wheel axles. Moreover, a wheelchair may be easily customized in many regards by the use of an axle engaging portion that can be attached, to and detached from, the wheelchair frame. An axle engaging portion may be selected according to a particular application or user so as to optimise the axle position and/or axle geometry for that application or user.

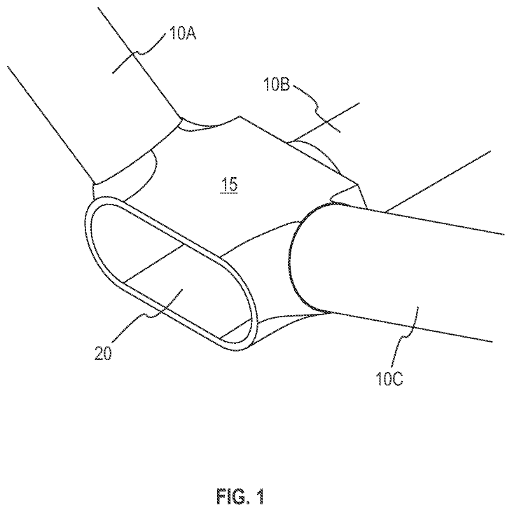

Turning firstly to FIG. 1, there is generally shown a portion of a wheelchair frame, about the position where the wheel axle inserts. The frame includes frame members (10A, 10B, 10C) that each mechanically attached to and support a socket (15), which broadly functions as a wheel support portion. The frame members (10A, 10B, 10C) may be fabricated according to any prior art material or design and attached to socket (15) by any means deemed suitable by the skilled artisan. Typically, the socket (15) will form a permanent part of the overall main frame of the wheelchair.

Socket (15) is generally thin-walled and may be fabricated from a strong but lightweight metal such as aluminium, although the wall thickens somewhat toward the attachment points for frame members (10A, 10B, 10C) to provide for greater structural integrity. Socket (15) provides a cavity (20) which, as will be explained more fully infra, is adapted to receive an axle support portion.

The socket (15), is in a suitable position so as to receive a wheelchair rear wheel axle. The view of FIG. 1 is from the lateral outside of the wheelchair, and accordingly the wheel will be disposed to the left (as drawn) of the socket (15). As will be appreciated, a complete wheelchair will have two sockets (15) each of which receives a wheelchair rear wheel axle.

Typically the wheel axles are disposed inferior to the seat and toward the seat backrest. However wheelchairs that are highly customised for sports and other activities may require the axles to be differently located.

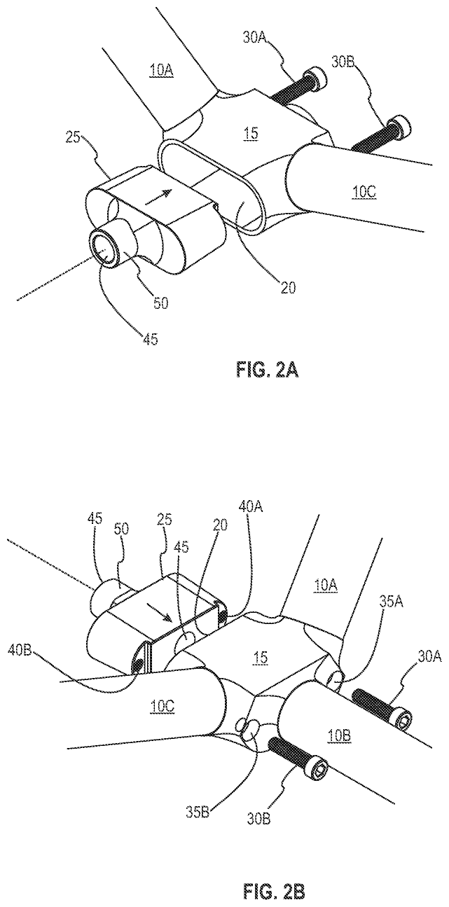

As shown in FIGS. 2A and 2B, the cavity (20) is shaped and dimensioned to receive a complementarily shaped and dimensioned axle engaging portion (25). In this embodiment, the cavity (15) has generally smooth interior surfaces and the axle engaging portion (25) has generally smooth exterior surfaces so as to allow the axle engaging portion (25) to slide into the cavity (20) and closely fit thereinto.

It is not intended that the axle engaging portion (25) frictionally engages with the cavity (15) to any material extent in this embodiment. At some point in time, it may be necessary to replace the axle engaging portion (25) with an alternative version so as to better suit the user or a particular application or circumstance. Any material frictional engagement may inhibit or prevent the easy removal of the installed axle engaging portion (25).

As will be appreciated, it is desirable that the axle engaging portion (20) is easily attachable and detachable, yet remain firmly in place when attached. In that regard, after installation the axle engaging portion (25) an impermanent fixing means may be used. In the preferred embodiment of the drawings, the fixing means comprises two threaded fasteners (30A, 30B) each of which winds into and engages with a complimentary thread formed in the axle engaging portion (25), as shown more clearly in FIG. 2B.

In FIG. 2B, the rear of the socket (15) is shown having two apertures (35A, 35B) each of which allows passage of the fastener (30A, 30B) shank, but not the fastener head.

The rear of the axle engaging portion (20) has threaded boreholes (40A, 40B) in register with apertures (35A, 35B) respectively.

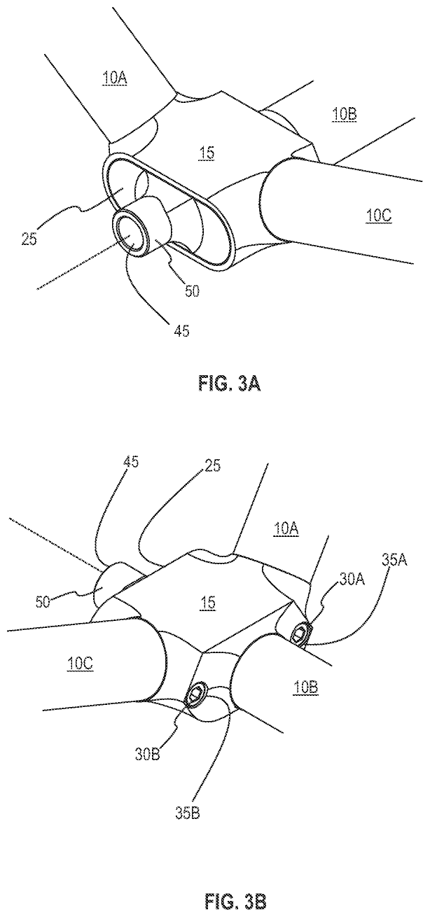

To attach the axle engaging portion (25), it is inserted into the cavity (20) so as to be fully seated therein. Fasteners (30A, 30B) are then inserted into apertures (35A, 35B) and advanced to the point whereby the ends of the threaded fasteners (30A, 30B) contact the thread of each threaded bore hole (40A, 40B) respectively. Threaded fasteners (30A, 30B) are then wound until the axle engaging portion (25) is firmly secured to the socket (15). Reference is made to FIG. 3A and FIG. 3B showing the axle engaging portion (25) attached to the socket (15), ready for the axle engaging portion (25) to engage with a rear wheel axle.

The axle (not drawn) is advanced toward the axle engaging portion (25) along the dashed line, and inserted into a passage (45) formed in the axle engaging portion (25) so as to be retained therein.

In this embodiment the axle engaging portion (25) comprises an extension portion (50) extending laterally outwardly from the wheel chair, and functioning to elongate the passage (45). An elongated passage (45) is preferred to better engage and support a useful length of the axle. As will be discussed further infra, an additional or alternative function for the extension portion (25) is to laterally offset the wheel axle (and therefore the wheel) away from the wheelchair so as to allow for fitting of broader tyres.

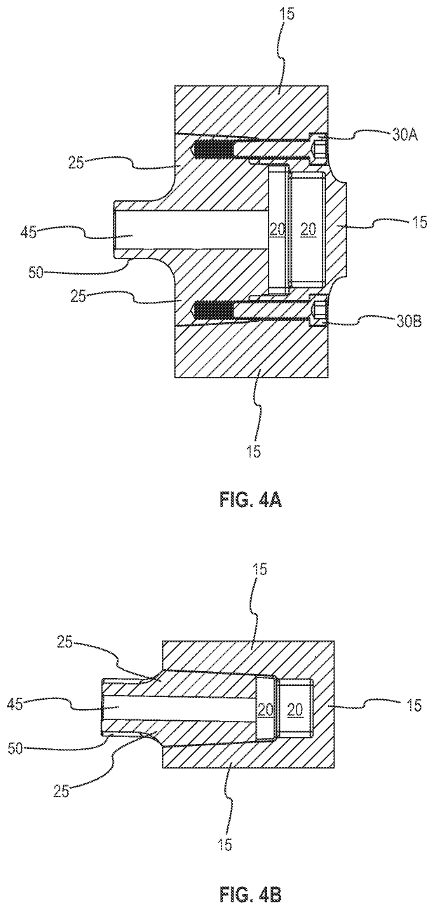

Turning now to FIGS. 4A and 4B, cross-sectional views are shown of the axle engaging portion (25) fully secured to the socket (15), ready to receive a wheel axle.

The wheel axle may be of the quick fit/quick release type having a retaining means which is engageable and disengageable by simply axially pushing and pulling the axle by hand. In some instances, the engagement and/or disengagement requires the user to actuate a locking and/or unlocking function. As one example, the retaining means of the axle may comprise a locking bearing in a terminal region of the axle, the bearing being movable radially so as to alternately extend beyond the cylindrical surface of the axle and sit within the axle. The bearing is biased toward the extended position.

In the context of the embodiment of FIG. 4A and FIG. 4B, the terminus of the axle is manually pushed into the passage (45), the walls of the passage (45) acting to depress the axle locking bearing so as to sit within the axle. One the terminus of the axle exits the passage (45) (and therefore also exits the axle engaging portion (25) the bearing moves radially outward (being biased to do so) and enters the portion of the cavity (20) immediately adjacent the passage (45) thereby inhibiting or preventing withdrawal of the axle from the passage (45).

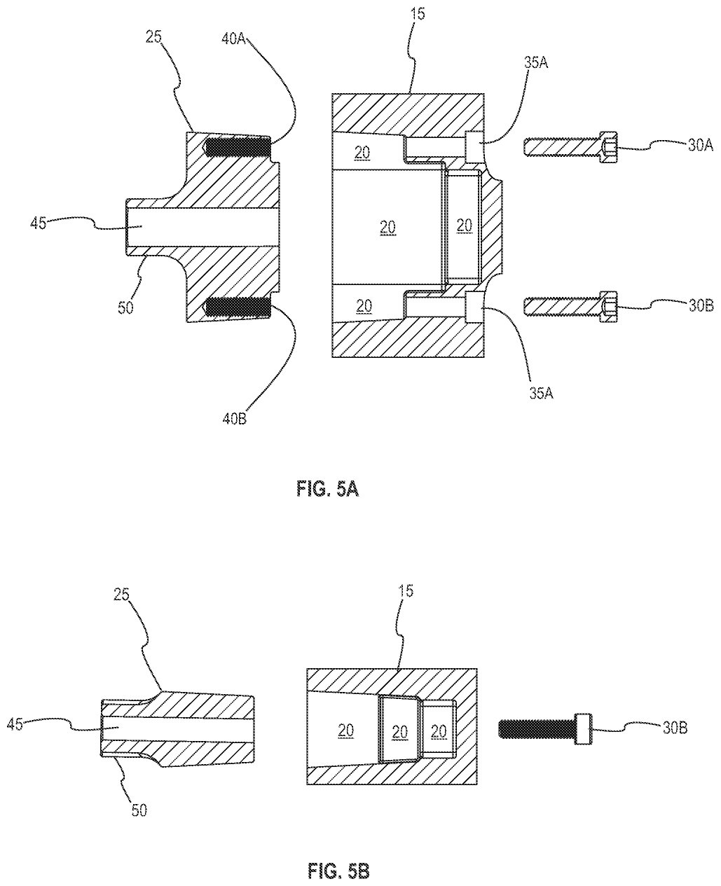

FIG. 5A and FIG. 5B are exploded views of the embodiment drawn in FIGS. 4A and 4B, provided to more particularly show the various components.

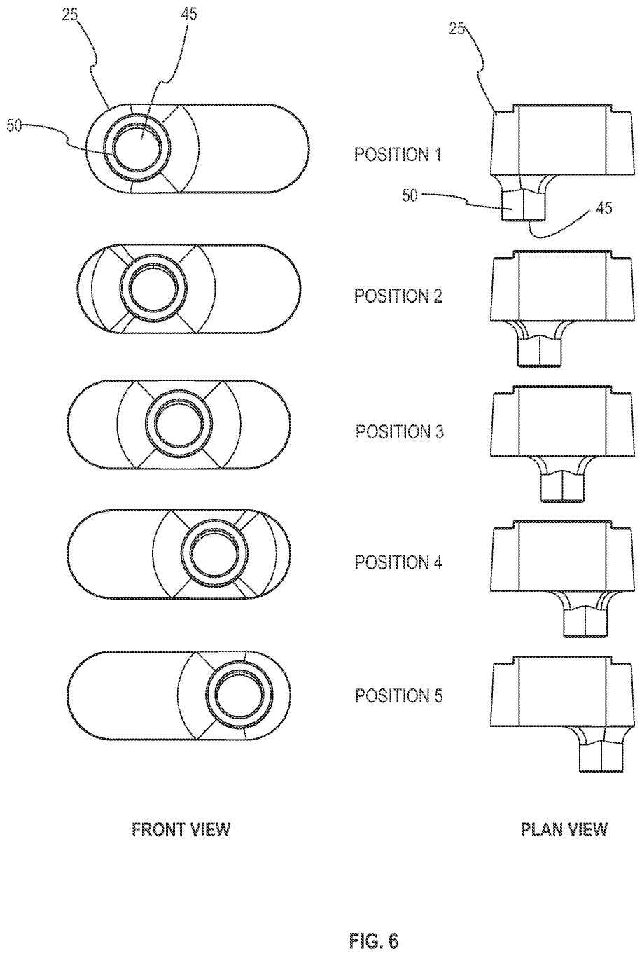

Turning now to FIG. 6, there are shown various types of axle engaging portions (25) useful for altering the position of the passage (45), and therefore altering the position of the wheel axle more forward or more rearward relative to the wheelchair as a whole. As will be noted, position 3 is a neutral (central) position. Position 1 shows the passage (45) in a forward-most position, and position 5 shows the passage (45) in a rear-most position. Adjusting the axle forward and rearward is desirable as it allows the user to change the wheelchair's centre of gravity, thus affecting their own centre of gravity and how the wheelchair rides and feels. This is often desirable if for example, the individual's condition changes (deteriorates or improves) or if attachments are added to the chair and affect the original weight distribution. This may also be used by a health professional such as an Occupational Therapist or a Physiotherapist if for example the nominal position when the wheelchair was custom-built for the individual was not quite correct. The present invention allows for simple and cost-efficient post-manufacture customisation and adjustability.

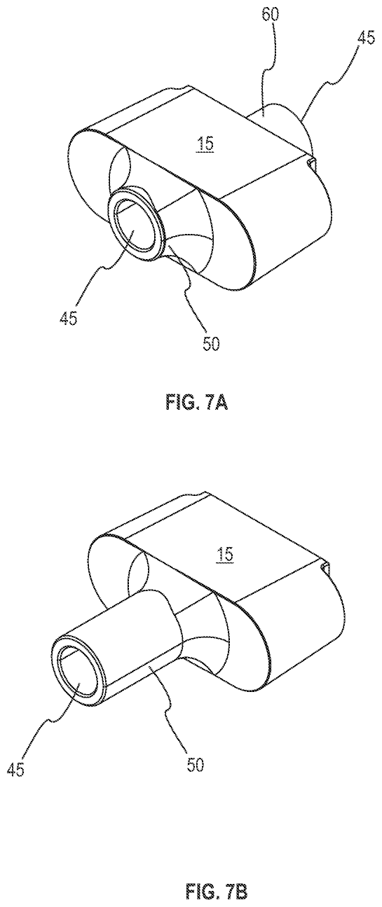

FIG. 7 shows alternative axle engaging portions (25) which can be utilised to alter the lateral offset of a wheelchair wheel. The embodiment of FIG. 7A shows an embodiment providing a relatively small offset, by virtue of a relatively short extended portion (50). FIG. 7B shows an embodiment providing a relatively large offset, by virtue of a relatively long extended portion (50). With regard to the embodiment of FIG. 7A, the very short extended portion (50) creates the problem of a shortened passage, with the attendant problem of there being insufficient passage length to engage with a useful length of axle. It is generally desirable to have minimal length of axle being unsupported so as to prevent bending of the axle under load. That problem is overcome by the inclusion of a support tube (60) extending from the rear face of the socket (15), the lumen of the tube (60) being coaxial and continuous with the passage (40). In this embodiment, a full length of axle is supported by the combination of the socket (15) and support tube (60). As will be appreciated, the cavity (20) must be sufficiently dimensioned so as to accommodate the support tube (60).

By the present invention, wheel offset can be increased when a user wishes to change general purpose wheels and tyres, to a set having a broader profile, so as to be more useful for traversing over soft materials such as sand or soil.

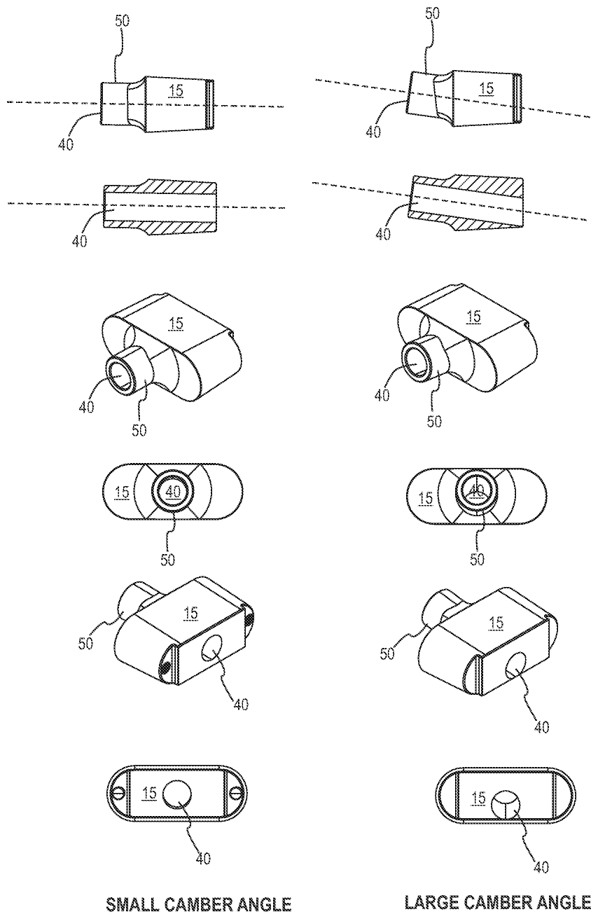

FIG. 8 shows alternative axle engaging portions (25) which can be utilised to alter the camber angle of a wheelchair wheel. The embodiment represented in the left-hand series of drawings provides a small camber angle (1 degree). The embodiment represented in the right-hand series of drawings provides a large camber angle (8 degrees). In reality, a camber angle as large as 8 degrees is unlikely to be useful. The exaggerated angle is chosen so as to more clearly illustrate the differences between the two embodiments.

As will be appreciated by comparing the left-hand and right-hand drawings, the high camber angle embodiment has a more highly angle extended portion (50) and passage (40). The passage (40) opens lower on the rear face of the socket (15) for the high camber angle embodiments, compared with the low camber angle embodiment.

An axle engaging portion may be configured so as to provide a desired setting for any two of: forward/rearward position, lateral offset and camber angle. An axle engaging portion may be configured so as to accomplish a desired forward/rearward position setting, lateral offset setting and camber angle setting.

Those skilled in the art will appreciate that the invention described herein is susceptible to further variations and modifications other than those specifically described. It is understood that the invention comprises all such variations and modifications which fall within the spirit and scope of the present invention.

For example, some embodiments of the invention do not rely on any cavity formed in the frame member to hold the axle engaging portion. For example, the axle engaging portion may comprise a cavity that is complimentary to a protuberance extending from the frame member.

Given the benefit of the present invention, the skilled person is enabled to design alternative means for attaching the axle engaging portion to the frame member. For example, the axle engaging portion may have a bolt hole extending all the way though, with a nut (preferably recessed) use to secure. As another example, a retaining plate extending across one or both faces of the cavity may be used to capture the axle engaging portion.

In another alternative embodiment of the invention, the cavity is itself threaded and the axle engaging portion has a complimentary thread and is wound into the cavity until secured.

Some embodiments do not rely on any cavity or protuberance. In one such embodiment, the axle engaging portion may be configured to fit onto a frame member. For example, the frame member may have a rear face shaped to fit onto a frame member. The frame member may have a circular cross-section and the axle engaging portion rear face may be curved to the same radius and closely fit thereon.

In some circumstances, the intention is for the axle engaging portion (20) to remain in situ for the operational life of the wheelchair. For example, a wheelchair retailer may permanently fit an axle engaging portion that suits a particular user and will be effective for all use scenarios foreseen by the user. The retailer may keep in stock wheelchairs having a cavity, and also a range of axle engaging portions from which the user may select. In this way, the retailer is not required to hold a range of wheelchairs in inventory having variable axle positions and geometries. Instead, a single wheelchair type may be stocked with customization achieved by the use of a selected axle engaging portion.

Where the axle engaging portion remains in situ for the operational life of the wheelchair, material frictional engagement with the cavity may be desirable and in which case smooth surfaces may not be required. A tool (such as a mallet) may be used to overcome the frictional forces between the parts and urge the axle engaging portion firmly into the cavity. In such cases, a permanent fixing means (such as a weld or an epoxy resin) or an impermanent fixing means (such as a threaded fastener) may be used as a further measure to prevent detachment of the axle engaging portion.

As will be clear from the above, the axle engaging portion (20) make take one of many forms, dependent in some embodiments on the configuration of the frame member to which it is to be attached. Regardless of the form, the function is to engage with an axle of one of the rear (main, larger) wheels of the wheelchair.

1. A system comprising:
a personal mobility apparatus comprising a wheel support portion, and
an axle engaging portion that is attachable to the wheel support portion.

2. The system of claim 1, wherein the axle engaging portion is detachable from the wheel support portion

3. The system of claim 1, wherein the wheel support portion is a body portion or a frame portion of the personal mobility apparatus.

4. The system of claim 1, wherein the axle engaging portion is formed separately to the wheel support portion.

5. The system of claim 1, wherein the wheel support portion is shaped so as to fit a complementary shape of the axle engaging portion.

6. The system of claim 5, wherein the complementary shape of the wheel support portion is (i) a cavity formed in the wheel support portion or (ii) a protuberance extending from the wheel support portion.

7. The system of claim 6, wherein the cavity or the protuberance is generally wedge-shaped in cross-section.

8. The system of claim 1 comprising reversible fixing means or a reversible fixing sub-system configured to reversibly fix the axle engaging portion to the wheel support portion.

9. The system of claim 8, wherein the reversible fixing means or the reversible fixing sub-system comprises any one or more of a fastener, a fastener hole formed in the wheel support portion and/or the axle engaging portion, a fastener receiving portion formed in the wheel support portion and/or the axle engaging portion, a clip, a band, or a clamp.

10. The system of claim 1, wherein the wheel support portion and/or the axle engaging portion is/are configured such that the axle engaging portion is attachable in a single orientation to the wheel support portion.

11. (canceled)

12. (canceled)

13. (canceled)

14. The system of claim 1, wherein the axle engaging portion is configured to reversibly engage a wheel axle intended for engagement.

15. The system of claim 14, wherein the reversible engagement is reliant on a structure of a wheel axle intended for engagement.

16. The system of claim 1, wherein the axle engaging portion comprises a passage configured to receive a wheel axle intended for engagement.

17. The system of claim 1, wherein the axle engaging portion comprises an extension portion configured to extend generally laterally outwardly from the personal mobility apparatus.

18. The system of claim 17, wherein the axle engaging portion comprises a passage configured to receive a wheel axle intended for engagement, and wherein the passage is formed at least in part in the extension portion.

19. The system of any one of claim 1, wherein the axle engaging portion is configured to engage a wheel axle at (i) a predetermined position relative to a point of the personal mobility apparatus, or relative to the ground and/or (ii) at an angle relative to the ground.

20. (canceled)

21. The system of claim 1, wherein the axle engaging portion is configured to engage a wheel axle in a more forward position or a more rearward position or a more upward position or a more downward position compared to a previous position or a standard position.

22. (canceled)

23. The system of claim 1 comprising a wheel axle configured to be engageable by the axle engaging portion.

24. The system of claim 1 comprising a range of axle engaging portions, each member of the range being differentially configured such that when attached to a frame member of a personal mobility apparatus, each member of the range positions and/or angles the axle differently.

25. (canceled)

26. The system of claim 1, wherein the personal mobility apparatus is a wheelchair.

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. (canceled)

57. (canceled)

58. (canceled)

59. (canceled)

60. (canceled)

61. (canceled)

62. (canceled)

63. (canceled)

64. (canceled)

65. (canceled)
